(19) United States
(12) Patent Application Publication
(10) Pub. No.: US 2026/0360132 A1
(43) Pub. Date: Nov. 12, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: TORU KOKURA, Kanagawa (JP)

(21) Appl. No.: 19/667,067

(22) Filed: May 4, 2026

(30) Foreign Application Priority Data
May 9, 2025 (JP) 2025-078877

(51) Int. Cl. G06V 10/776; G06N 3/08; G06V 10/778; G06V 10/82

(52) U.S. Cl. CPC G06V 10/776; G06N 3/08; G06V 10/778; G06V 10/82

(57) ABSTRACT

An information processing apparatus comprises at least one processor and at least one memory that is in communication with the at least one processor. The at least one memory stores instructions for causing the at least one processor and the at least one memory to acquire configuration information defining a learning model, acquire history information indicating a history concerning processing of the learning model, and generate an output file of the learning model by storing the configuration information and the history information in a file storing the learning model.

### BACKGROUND

### Field of the Technology

The present disclosure relates to a technique of generating a file storing a learning model.

### DESCRIPTION OF THE RELATED ART

In recent years, image recognition techniques using machine learning, image-quality enhancing techniques, and the like have developed remarkably, and have been applied to various products and services. Most recently, AI, called generative AI, that generates content such as a sentence or an image based on a user input has appeared and received a great deal of attention.

Many of the techniques are implemented by learning models created by companies, research institutes, and the like. However, in recent years, execution of machine learning in accordance with a user's application to create a learning model by a general user is becoming widespread. Along with this, there are many services through the Internet that allow execution of machine learning, publication of a learning model, and the like by a general user. Such service will be referred to as a learning model public platform hereinafter. On the learning model public platform, it is possible to download and use a learning model published by another user. There exists a learning model public platform having a mechanism of paying part of the download fee to the learning model creator as a compensation, thereby promoting activation of model creation by the user on the learning model public platform.

To efficiently and accurately create a model, there is generally known a method of selecting, as an initial model, a model having an output characteristic suitable for a user's application or a model superior in performance from learning models published by other users and then performing incremental learning. To know the output characteristics and performance from an enormous number of learning models published on the learning model public platform, it is effective to refer to the history of the learning models at the time of past learning/evaluation/inference. For example, a model with a sufficient evaluation value is selected based on the past evaluation history, or a model with few artifacts is selected based on the past inference history. Japanese Patent No. 7289588 discloses a technique of recording a learned model file and a learning or test history file and managing them in a ledger.

In the above-described method, a file (to be referred to as a model file hereinafter) that records parameters acquired by learning and a file (to be referred to as a history information file hereinafter) that records history information are individually managed. Therefore, to exchange the history information together with the model file in linkage with each other on the platform, each user needs to transmit/receive both the files in association with each other and a platform administrator (administrator user) needs to manage both the files in association with each other, thereby complicating management. There is a risk that the link information may be lost by erroneously moving or deleting one of the files. In addition, the model file and the history information file are stored as different files, thereby decreasing the speed of parsing of the files. Furthermore, if a write is executed to the plurality of files from a plurality of threads, there is a risk that consistency between the files may be lost due to access violation.

### SUMMARY

Embodiments of the present disclosure provide a technique for improving convenience of a file storing a learning model.

According to an aspect of the present disclosure, there is provided an information processing apparatus comprising at least one processor and at least one memory that is in communication with the at least one processor. The at least one memory stores instructions for causing the at least one processor and the at least one memory to acquire configuration information defining a learning model, acquire history information indicating a history concerning processing of the learning model, and generate an output file of the learning model by storing the configuration information and the history information in a file storing the learning model.

Features of various embodiments will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing an example of the configuration of a system.

FIG. 2 is a block diagram showing an example of the hardware configurations of a cloud server 200 and a device 100.

FIG. 3 is a block diagram showing an example of the functional configurations of the cloud server 200 and the device 100.

FIG. 4 is a flowchart of the operation of the device 100.

FIG. 5 is a view showing an example of the structure of an output model file.

FIG. 6 is a flowchart of the operation of a device 100.

FIG. 7A is a view showing an example of the display of a window.

FIG. 7B is a view showing an example of the display of a window.

FIG. 7C is a view showing an example of the display of a window.

FIG. 8 is a flowchart of the operation of a device 100.

FIG. 9A is a view showing an example of the display of a window.

FIG. 9B is a view showing an example of the display of a window.

FIG. 9C is a view showing an example of the display of a window.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

This embodiment will describe a case where a file including a learning model that performs recognition processing as processing of recognizing (inferring) the position and classification (attribute) of an object in an input image and outputting the result of the recognition is generated as a model file. Note that this embodiment will describe a case where a hierarchical neural network is used as a learning model but a model usable as a learning model is not limited to the hierarchical neural network. For example, a model such as a decision tree or SVM may be used as a learning model, or a model such as a partial model obtained by extracting a part of the neural network may be used as a learning model. In addition, a task executed by the learning model is not limited to the recognition processing, and may be another task such as image-quality enhancing processing, image generation processing, sound processing, and language processing.

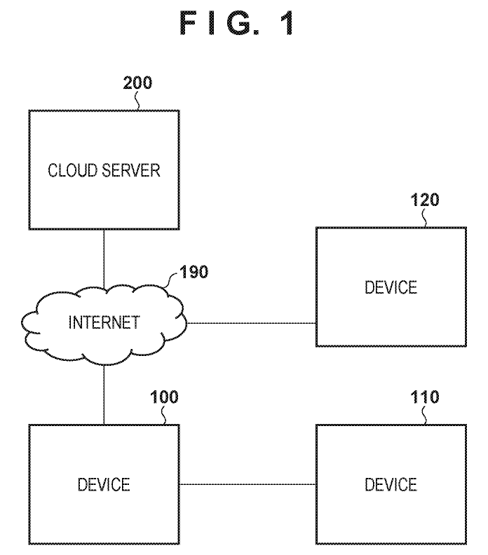

An example of the configuration of a system according to this embodiment will be described first with reference to the block diagram of FIG. 1. As shown in FIG. 1, the system according to this embodiment includes a cloud server 200 and devices 100, 110, and 120. The cloud server 200 and the devices 100 and 120 are connected to the Internet 190, and the device 110 is connected to the device 100 via a local network.

The cloud server 200 stores model files, and the user can acquire a model file from the cloud server 200 by accessing the cloud server 200 using the device 100, 110, or 120 or the like, as needed, and register a model file in the cloud server 200.

Each of the devices 100, 110, and 120 is a terminal apparatus operated by the user, and is used to, for example, acquire a model file from the cloud server 200 and register a model file in the cloud server 200. Each of the devices 100, 110, and 120 is a computer apparatus such as a PC, a tablet terminal apparatus, or a smartphone.

For example, the device 100 downloads, on itself, a model file selected from the model files registered in the cloud server 200, and performs relearning of a learning model stored in the downloaded model file. Then, the device 100 uploads, to the cloud server 200, the model file storing the relearned learning model. Such operation from downloading of the model file to uploading of the model file may be performed by another device such as the device 110 or 120.

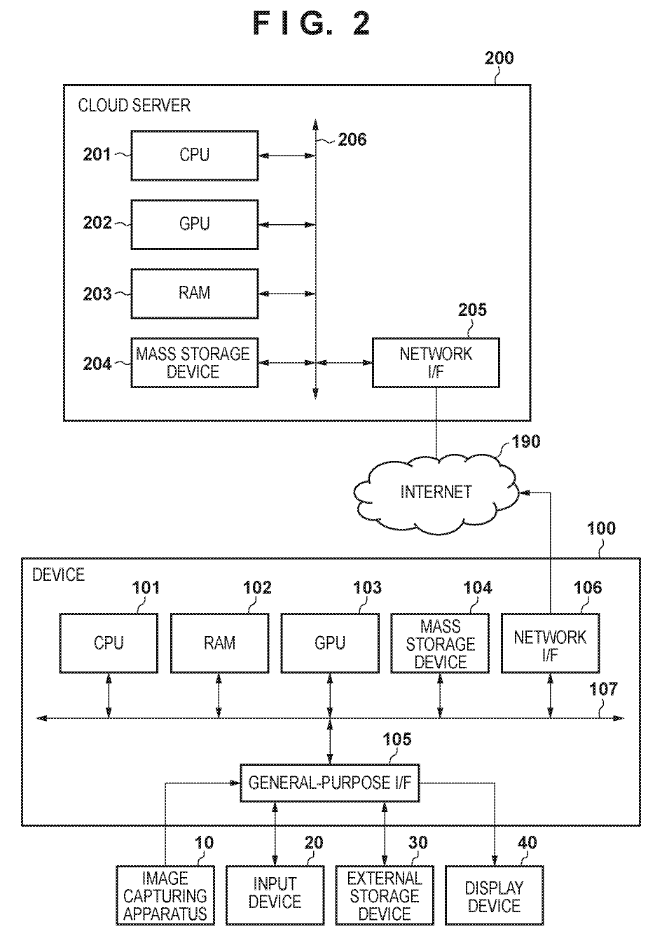

Next, an example of the hardware configurations of the cloud server 200 and the device 100 will be described with reference to the block diagram of FIG. 2. Note that in this embodiment, the hardware configurations of the devices 110 and 120 are assumed to be the same as that of the device 100 and are not illustrated in FIG. 2, but the hardware configurations of the devices 110 and 120 may be different from that of the device 100.

First, an example of the hardware configuration of the cloud server 200 will be described. A CPU 201 executes various kinds of processes using computer programs and data stored in a RAM 203. Thus, the CPU 201 controls the operation of the entire cloud server 200, and executes or controls various kinds of processes to be explained as processes to be performed by the cloud server 200. A GPU 202 executes various kinds of processes including operation processing using computer programs and data stored in the RAM 203 under the control of the CPU 201.

The RAM 203 includes an area configured to store computer programs and data loaded from a mass storage device 204, and an area configured to store computer programs and data received from an external apparatus via a network I/F 205. The RAM 203 also includes a work area used when the CPU 201 or the GPU 202 executes various kinds of processes. Thus, the RAM 203 can appropriately provide various kinds of areas.

The mass storage device 204 is a nonvolatile mass information storage device such as a hard disk drive or a solid state drive. The mass storage device 204 stores an OS, an uploaded model file, computer programs and data for causing the CPU 201 or the GPU 202 to execute or control various kinds of processes to be explained as processes performed by the cloud server 200, and the like.

Note that a model file may be stored in an external apparatus different from the cloud server 200. In this case, the device 100 may upload/download a model file to/from the external apparatus via the cloud server 200 or directly upload/download a model file to/from the external apparatus.

The network I/F 205 is a communication interface for performing data communication with an external apparatus via the Internet 190. All of the CPU 201, the GPU 202, the RAM 203, the mass storage device 204, and the network I/F 205 are connected to a system bus 206.

Next, an example of the hardware configuration of the device 100 will be described. A CPU 101 executes various kinds of processes using computer programs and data stored in a RAM 102. Thus, the CPU 101 controls the operation of the entire device 100, and executes or controls various kinds of processes to be explained as processes to be performed by the device 100.

The RAM 102 includes an area configured to store computer programs and data loaded from a mass storage device 104, and an area configured to store computer programs and data received from an external apparatus via a network I/F 106. The RAM 102 also includes an area configured to store computer programs and data transferred via a general-purpose I/F 105. Furthermore, the RAM 102 includes a work area used when the CPU 101 or a GPU 103 executes various kinds of processes. Thus, the RAM 102 can appropriately provide various kinds of areas. The GPU 103 executes various kinds of processes including operation processing using computer programs and data stored in the RAM 102 under the control of the CPU 101.

The mass storage device 104 is a nonvolatile mass information storage device such as a hard disk drive or a solid state drive. The mass storage device 104 stores an OS, computer programs and data for causing the CPU 101 or the GPU 103 to execute or control various kinds of processes to be explained as processes performed by the device 100, and the like. The network I/F 106 is a communication interface for performing data communication with an external apparatus via the Internet 190.

The general-purpose I/F 105 is, for example, a serial bus interface such as USB, IEEE1394, and HDMI. The general-purpose I/F 105 is connected to an image capturing apparatus 10, an input device 20, an external storage device 30, and a display device 40.

The image capturing apparatus 10 is an image capturing apparatus capable of capturing a moving image and a still image. The input device 20 is a user interface such as a keyboard, a mouse, or a touch panel, and the user can input various kinds of instructions or information to the device 100 by operating the input device 20.

The external storage device 30 is a memory device externally attachable to the device 100. For example, the external storage device 30 is a memory device detachable from the device 100, and includes various kinds of storage media such as a memory card, a CF card, an SD card, and a USB memory. A part of information stored in the mass storage device 104 may be stored in the external storage device 30. The display device 40 is a device including a liquid crystal screen or a touch panel screen, and can display the processing result of the CPU 101 or the GPU 103 by an image, characters, or the like. All of the CPU 101, the RAM 102, the GPU 103, the mass storage device 104, the general-purpose I/F 105, and the network I/F 106 are connected to a system bus 107.

For example, the device 100 accesses the cloud server 200 by a Web browser, and requests a model file from the cloud server 200. In response to the request, the cloud server 200 transmits the model file to the device 100.

The device 100 executes processing such as relearning, inference, and information acquisition of the learning model using the downloaded model file. Note that the device 100 may request another device (device 110 or 120) to perform a part of the processing such as relearning, inference, and information acquisition of the learning model. In this case, the device 100 acquires, from the device that has been requested to perform the processing, the processing result of the device.

For example, the device 100 uploads (transmits) a model file to the cloud server 200 by a Web browser. The cloud server 200 receives the model file uploaded (transmitted) from the device 100 and stores (registers) it in the mass storage device 204.

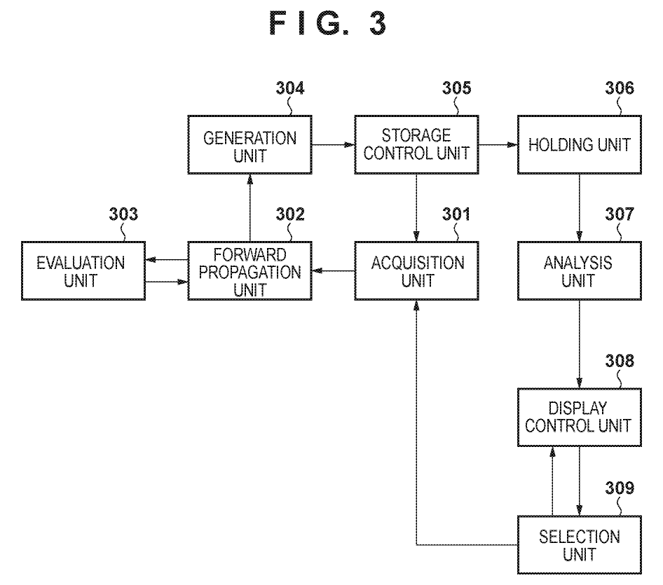

Next, an example of the functional configurations of the cloud server 200 and the device 100 is shown in the block diagram of FIG. 3. In FIG. 3, a holding unit 306 is a function unit of the cloud server 200, and can be implemented using, for example, the mass storage device 204. All function units except for the holding unit 306 in FIG. 3 are the function units of the device 100, and may be implemented by hardware or software (computer programs). A case where all the function units of the device 100 are implemented by software will be described below. The function units of the device 100 will be described as the main constituent of processing. However, in fact, the functions of the function units are implemented when the CPU 101 executes computer programs corresponding to the function units. Note that one or more of the function units of the device 100 may be implemented by hardware.

The configuration shown in FIG. 3 can appropriately be modified or changed. For example, one function unit may be divided into a plurality of function units, or two or more function units may be integrated into one function unit.

The configuration of each apparatus shown in FIG. 2 may be implemented by two or more apparatuses. In this case, the apparatuses are connected via a circuit or a wired or wireless network and perform cooperative operations by performing data communication with each other, thereby implementing each process to be described later.

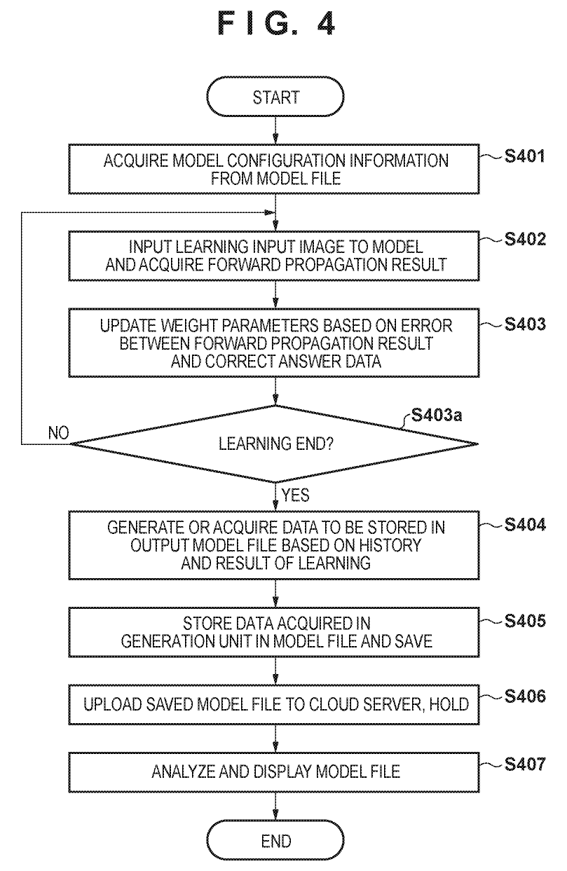

Next, the operation of the device 100 will be described with reference to the flowchart of FIG. 4. In step S401, an acquisition unit 301 transmits an acquisition request of a model file to the cloud server 200, and receives (acquires) the model file transmitted in accordance with the acquisition request by the cloud server 200. Then, the acquisition unit 301 reads out model configuration information from the received model file.

The model configuration information is configuration information that defines a learning model stored in the model file, and includes architecture information indicating the types of operations and the order of application in the learning model (defining the hierarchical structure of the learning model), and weight parameters as the coefficients of the operations.

The acquisition unit 301 forms the hierarchical structure of the learning model defined by the types of operations and the order of application indicated by the architecture information, and sets, for each layer of the learning model, the weight parameters corresponding to the layer, thereby generating a learning model to be used in subsequent processing.

Note that the acquisition source of the model file is not limited to the cloud server 200 and may be, for example, the mass storage device 104 or another device (for example, the device 110 or 120).

In step S402, a forward propagation unit 302 acquires an input image (learning image) for learning of the learning model. A method of acquiring a learning image is not limited to a specific one. For example, the forward propagation unit 302 may acquire, as a learning image, an image captured by the image capturing apparatus 10 or an image stored in the mass storage device 104. Alternatively, the forward propagation unit 302 may acquire a learning image from an external apparatus via the network I/F 106.

Then, the forward propagation unit 302 performs an operation (forward propagation) of the learning model by inputting the learning image to the learning model, thereby acquiring, as a forward propagation result, the position and classification of an object in the learning image.

In step S403, an evaluation unit 303 calculates, as an evaluation value, an error (loss value) between the forward propagation result acquired in step S402 and the correct answer data of the position and classification of the object in the learning image. A method of acquiring the correct answer data is not limited to a specific one, like the learning image. The evaluation value is based on the magnitude of each of a deviation amount from the predicted position of the object and the incorrect answer rate of the classification. Then, the evaluation unit 303 updates the current weight parameters of the learning model so as to decrease the evaluation value.

A set of the processing of step S402 and the processing of step S403 is learning processing of the learning model, and this learning processing is repeatedly performed until the end condition of the learning processing is satisfied.

In step S403a, the forward propagation unit 302 determines whether the end condition of the learning processing is satisfied. The end condition of the learning processing is not limited to a specific condition. For example, "the repetition count of the learning processing is equal to or larger than a threshold", "the evaluation value is smaller than a threshold", "the change rate of the evaluation value is smaller than a threshold", "the elapsed time from the start of the learning processing is equal to or longer than a threshold", or the like can be applied as the end condition of the learning processing.

As a result of the determination, if the end condition of the learning processing is satisfied, the process advances to step S404, and if the end condition of the learning processing is not satisfied, the process returns to step S402.

In step S404, a generation unit 304 acquires data to be stored in the model file based on the history of the learning processing and various kinds of information obtained in the learning processing. The data acquired by the generation unit 304 includes, for example, model configuration information, the history of the learning image, the history of the forward propagation result, and the operation history of the learning model.

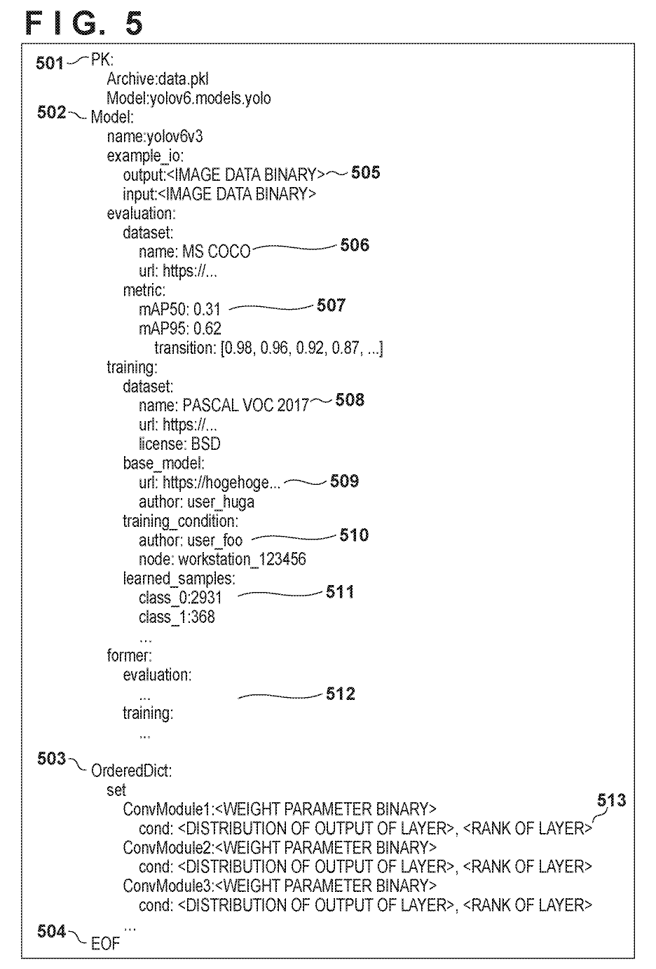

In step S405, a storage control unit 305 stores the data acquired in step S404 in the model file acquired in step S401, thereby generating a model file (output model file: output file) to be uploaded to the cloud server 200. An example of the structure of the output model file will be described with reference to FIG. 5.

As the format of the model file, there is known a model file format including a file start symbol 501, an overall information description region 502 as a region for describing information of the entire learning model such as the file name of the model file and the file size of the model file, a partial information description region 503 as a region for describing information in the learning model such as architecture information and weight parameters, and a file end symbol 504. The information of the entire learning model and the information in the learning model are divisionally described, which is useful for speeding up file parsing and reducing the load of information management.

In this embodiment, the storage control unit 305 generates an output model file by divisionally storing the data acquired in step S404 in the overall information description region 502 and the model partial information description region 503 in the model file having the above format. The operation of the storage control unit 305 will be described in more detail below.

As an item 505, the storage control unit 305 stores, as history information, in the overall information description region 502, the history of an input image input as a learning image to a learning model in learning processing of the learning model and the history of a forward propagation result corresponding to the input image. Note that in a case where inference by a learned learning model is performed, the storage control unit 305 stores, as history information, in the overall information description region 502, the history of an input image input to the learning model at the time of inference and the history of a forward propagation result corresponding to the input image. In a case where evaluation of a learning model is performed, the storage control unit 305 stores, as history information, in the overall information description region 502, the history of an input image input to the learning model for the evaluation and the history of a forward propagation result corresponding to the input image. Evaluation of a learning model is, for example, processing of calculating a forward propagation result corresponding to input data for evaluation by inputting the input data to the learning model and performing an operation of the learning model and calculating, as an evaluation value, an error (loss value) between the forward propagation result and correct answer data corresponding to the input data.

Note that the input image (input data) and the forward propagation result (output data) may be stored in the model file after applying post-processing such as visualization and statistical processing. For example, a superimposed image obtained by superimposing information indicating the output object position on the input image may be stored in the model file. Storing the data applied with post-processing is useful for promoting understanding when the data is presented to the user and improving the processing speed when the data is mechanically analyzed.

As an item 506, the storage control unit 305 stores, as history information, in the overall information description region 502, the name and acquisition source of a data set (input data for evaluation and correct answer data corresponding to the input data) for evaluation of the learning model. The acquisition source of the data set is described in a format such as an online URL or a path in the device 100.

As an item 507, the storage control unit 305 stores, as history information, in the overall information description region 502, the evaluation value calculated by evaluating the learning model by the evaluation unit 303 and the identifier of the evaluation index of the evaluation value. The identifier of the evaluation index of the evaluation value is the identifier of information concerning an evaluation value calculation method, and a link to an evaluation value calculation formula and calculation method may additionally be included. The storage control unit 305 stores, as the evaluation value, the evaluation value upon completion of the learning processing and the history (series data) of the evaluation value during the learning processing.

As an item 508, the storage control unit 305 stores, as history information, in the overall information description region 502, the name of learning data (a learning image and correct answer data), a link to the acquisition source of the learning data, and the license of the learning data.

As an item 509, the storage control unit 305 stores, as history information, in the overall information description region 502, the model name of the learning model (learning target learning model) in the model file acquired by the acquisition unit 301, a link to the model file, and information concerning the creator of the learning model.

As an item 510, the storage control unit 305 stores the condition at the time of learning processing as history information in the overall information description region 502. The condition at the time of learning processing can include, for example, the identifier of a user who has instructed to execute the learning processing, the identifier of a node that has executed the learning processing, and the date/time when the learning processing is executed. The identifier of the user who has instructed to execute the learning processing need only be information capable of specifying the user, such as a user name, a user account, a user ID, or a user Web page link.

As an item 511, the storage control unit 305 stores, as history information, in the overall information description region 502, statistical information of samples (learning data) used in the learning processing. The statistical information of samples used in learning can include, for example, the distribution of the supervisory label of the learning data used in the learning processing so far, the distribution of a subject in the learning image, and the color distribution of the learning image.

As an item 512, the storage control unit 305 stores, as history information, in the overall information description region 502 of the output model file, the information of the overall information description region 502 of the model file acquired by the acquisition unit 301. Note that the storage method need not be limited to the above-described storage method as long as the history at the time of past learning processing/evaluation/inference is inherited into the current model file. For example, when the item 511 is described, a statistical value obtained by combining the past learning processing and the current learning processing may be described.

The storage control unit 305 analyzes, for each layer of the learning model, the characteristic of the layer such as the distribution measured from the output of the layer and the rank of the output matrix of the layer. Then, as an item 513, the storage control unit 305 stores, as history information, in the partial information description region 503, the history of the result of the analysis (the characteristic of each layer of the learning model) in association with a portion where the model configuration information (architecture information and weight parameters) of the learned learning model is described.

As the output value of the layer in the learning model, for example, an output value obtained for each layer in forward propagation in step S402 is used. By storing the output value for each layer in the model file, it is possible to perform analysis for weight reduction and learning of the learning model for each layer.

Note that the method of storing information in the model file is not limited to the above-described one. For example, only a statistical value or a representative value may be stored as each piece of information to reduce the model file. Alternatively, the information stored in the model file may be a part of the above information, or information other than the above information may additionally be stored. Furthermore, a case where the storage processing of step S405 is performed after completion of forward propagation of step S402 has been explained above but the amount of information written per processing may be reduced by writing information in the model file as needed during execution of forward propagation.

Referring back to FIG. 4, in step S406, when the output model file is completed, the storage control unit 305 transmits (uploads) the completed output model file to the cloud server 200. Note that the upload destination of the output model file is not limited to the cloud server 200 and may be another device (for example, the device 110 or 120).

In step S407, an analysis unit 307 analyzes the output model file uploaded by the storage control unit 305, and acquires information from the overall information description region 502 and the partial information description region 503. Then, a display control unit 308 displays the acquired information on, for example, the display device 40 by using an image or characters. The user can grasp the output characteristic and performance of the learning model by browsing the acquired information.

As described above, according to this embodiment, by storing the model configuration information and the history information in the same model file and outputting the model file, there is a need to communicate only one file when transmitting/receiving the model file, thereby reducing user's labor. According to this embodiment, it is possible to reduce the risk of operational errors such as erroneous deletion of only the history file and a loss of linkage with the model file by moving the history file. As described above, according to this embodiment, it is possible to improve convenience of management of the model file and the history information.

### Modification 1

The first embodiment has explained an example of downloading the model file from the cloud server 200 and performing incremental learning on the device 100. This modification will describe an example of performing only inference on the device 100 without performing incremental learning. Differences from the first embodiment will be described below, and the rest is the same as in the first embodiment unless it is specifically stated otherwise. In this modification, the device 100 does not execute the processes of steps S403, S403a, and S404 in the flowchart of FIG. 4, and steps S402 and S405 are different from those in the first embodiment.

In step S402, the forward propagation unit 302 acquires an input image for inference. A method of acquiring an input image for inference is not limited to a specific one, similar to the method of acquiring the learning image. Then, the forward propagation unit 302 inputs the input image to the learning model and performs an operation (forward propagation) of the learning model, thereby acquiring, as a forward propagation result (inference result), the position and classification of an object in the input image.

In step S405, the storage control unit 305 stores, as the item 505, the history of the input image for inference and the history of the forward propagation result corresponding to the input image in the overall information description region 502.

The thus obtained model file stores an input/output example at each point of time. When another user uses it, he/she can grasp an output characteristic and performance such as image quality from the past input/output example without resuming operation of the model.

### Modification 2

The first embodiment does not mention the number of threads when performing forward propagation and write to the model file. To speed up the processing, it is considered to perform forward propagation and write to the model file using multithreading. However, in the method described in Japanese Patent No. 7289588, the model file and the history information file are separately held, and thus there is the risk of file damage such as version mismatching between the files depending on the timings of writing from multithread. This modification will describe a case where forward propagation and write to the model file are performed using multithreading in order to speed up the processing.

Differences from the first embodiment will be described below, and the rest is the same as in the first embodiment unless it is specifically stated otherwise. In this modification, steps S402 and S405 performed by the device 100 in the flowchart of FIG. 4 are different from those in the first embodiment.

In step S402, the forward propagation unit 302 executes, in a plurality of threads, processing of inputting a learning image to a learning model and performing an operation (forward propagation) of the learning model to acquire, as a forward propagation result, the position and classification of an object in the learning image.

In step S405, the storage control unit 305 controls, by exclusive control, processing of storing, in the model file, data obtained in the plurality of threads (writing data in the model file in the plurality of threads). More specifically, when starting a write to the model file in a given thread, the storage control unit 305 prohibits write in another thread. Then, upon completion of the write of the data to the model file in the current thread, the storage control unit 305 permits write in the other thread.

As described above, it is possible to implement high-speed multithread processing with a low risk of losing the consistency between files due to access violation without imposing, on the user, the complexity of individually managing the model file and the file indicating history information.

### Second Embodiment

Each of the following embodiments including this embodiment will describe differences from the first embodiment, and the rest is the same as in the first embodiment unless it is specifically stated otherwise. This embodiment will describe a case where information for simplifying a model selection operation by a user is provided by acquiring the past history from a model file. More specifically, this embodiment will describe a case where the user selects a learning model as an image generation model from a cloud server 200 (learning model public platform). Note that this embodiment does not limit the learning model to the image generation model, and may use a model that executes a general task such as image-quality enhancing processing, image recognition, sound processing, and language processing.

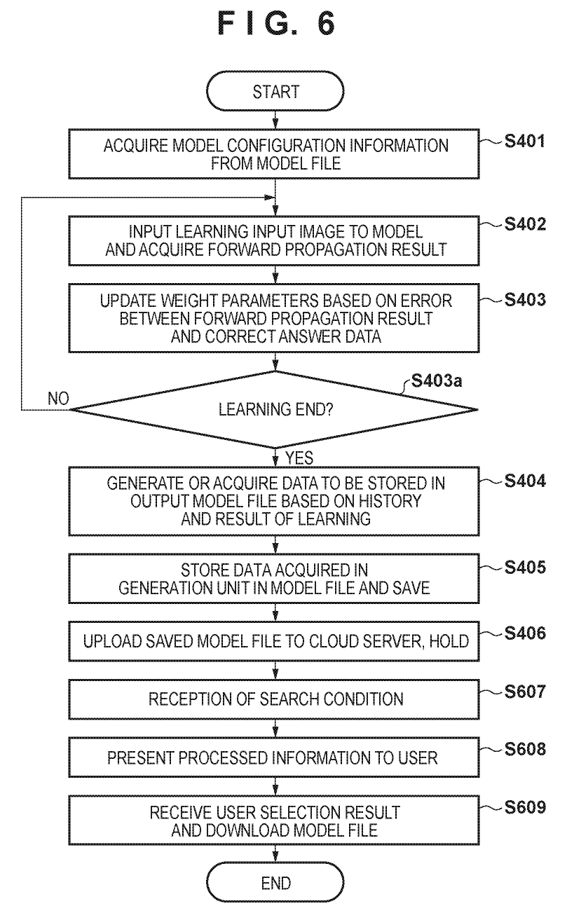

The operation of a device 100 will be described with reference to the flowchart of FIG. 6. In FIG. 6, the same step numbers of processing steps as in FIG. 4 denote the same processing steps and a description thereof will be omitted.

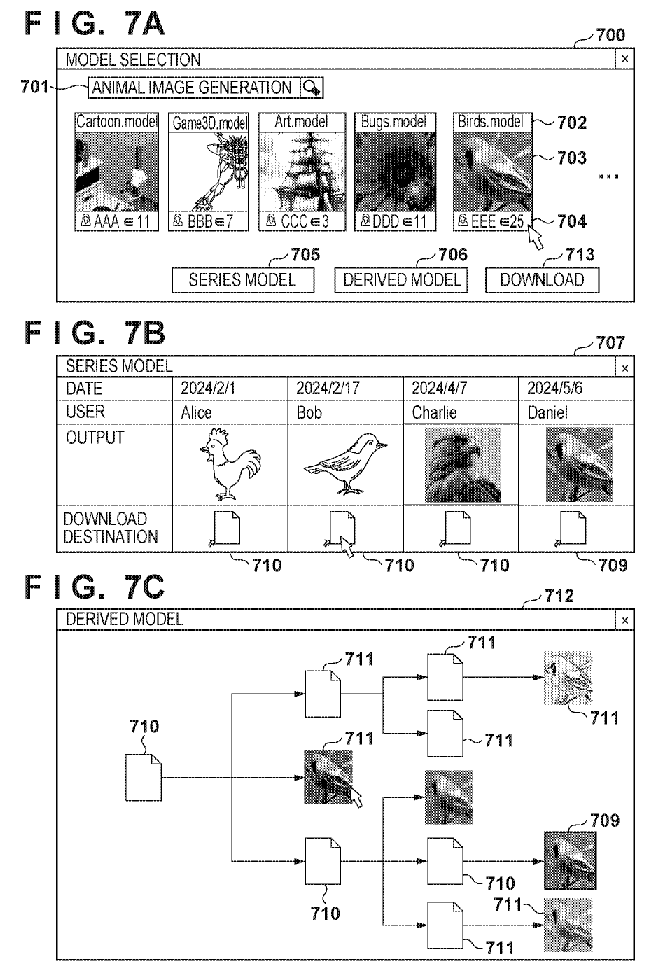

In step S607, a display control unit 308 displays a dialog window 700 exemplified in FIG. 7A on a display device 40, and prompts the user to input, to a box 701, a search condition of a learning model to be acquired. The user inputs, to the box 701 using an input device 20, a search condition of a learning model to be acquired.

When the user inputs a search instruction using the input device 20, an analysis unit 307 requests the cloud server 200 to search for learning models under the search condition and transmit the model files of the learning models found by the search.

The cloud server 200 performs a search in accordance with the request to search for learning models matching the search condition input by the user, and transmits the model files of the found learning models to the device 100. The analysis unit 307 acquires (receives) the model files transmitted from the cloud server 200.

In step S608, the display control unit 308 displays, on the window 700, information included in each model file acquired by the analysis unit 307 from the cloud server 200, as exemplified in FIG. 7A.

The information displayed on the window 700 includes a model name 702 of the learning model, a forward propagation result 703, and additional information 704 such as a user name and evaluation information. The model name of a learning model stored as an item 509 is displayed as the model name 702 of the learning model, and the history of a forward propagation result stored as an item 505 is displayed as the forward propagation result 703. Corresponding items are displayed as the additional information 704 such as a user name and evaluation information. By taking this display form, the user can compare generated image examples of the learning models with each other, and thus intuitively select a learning model to be employed.

The user selects, using the input device 20, one of the pieces of information (model name 702, forward propagation result 703, and additional information 704) of the learning model to be acquired. Then, when the user makes an instruction on a button 705 using the input device 20, the display control unit 308 displays, on the display device 40, a window 707 for displaying information of series models of the learning model corresponding to the selected information, as shown in FIG. 7B.

When an operation of regenerating a model file by changing the user/machine/learning condition and performing incremental learning with respect to the learning model learned in accordance with an instruction of a given user is repeated, a series of model files (series model files) having the inheritance relation are generated.

The display control unit 308 searches for, from model files registered in the cloud server 200, as a series model file that is the model file of a series model of "the learning model selected by the user", a model file in which the model name of the "learning model selected by the user" is described in the item 509. Note that a method of acquiring a series model file corresponding to the learning model selected by the user is not limited to the above-described one.

Then, the display control unit 308 acquires the learning date/time, creating user, forward propagation result example, and download destination of a series model file with reference to an overall information description region 502 stored as an item 512 in the series model file, and displays them on the window 707, as shown in FIG. 7B. By taking this display form, for example, if a learning model better matching user preference than a learning model 709 selected on the window 700 exists in a series model group 710, the user can select it.

When the user makes an instruction on a button 706 using the input device 20 on the window 700, the display control unit 308 displays, on the display screen of the display device 40, a window 712 for displaying derived models of the selected learning model, as shown in FIG. 7C.

A model file created by performing incremental learning using the selected model 709 and the series model group 710 will be referred to as a derived model hereinafter. The display control unit 308 refers to the items 509 and 512 with respect to a derived model group 711, and displays the derivational relation and output history. Analysis of the derivational relation is implemented by searching for, from the learning models in the cloud server 200, the learning model in which a series model and the selected model are described in the item 509. If a learning model better matching user preference than the learning model 709 selected on the window 700 exists in the derived model group 711, the user selects it. By visually presenting the series models and derived models to the user, the user can select a learning model better matching preference from learning models similar to the initially selected learning model.

In step S609, when the user makes an instruction on a button 713 using the input device 20, a selection unit 309 transmits an acquisition request of the model file of the learning model selected by the user to the cloud server 200. The cloud server 200 transmits, to the device 100, the model file corresponding to the acquisition request.

Note that sharing of the processing between the apparatuses is not limited to the above-described case. For example, an image of the window 700 may be drawn by reading the history information of the model files on the cloud server 200 and then transmitted to the device 100.

In addition, to reduce the operation amount for analyzing the derivational relation, when creating a new model file, the storage control unit 305 may store, as an item for storing the derivational relation, the relation with a link to the new model file in the model file described in the item 509. This allows the user to refer to the derivational relation of the model at high speed.

In the additional information 704, information serving as an index for model selection may additionally be described. For example, the number of model files derived from the target file may be counted and described in the additional information 704. This can visualize, at the time of selection, a model with a large number of derivatives as a model with performance preferred by other users.

The analysis unit 307, the display control unit 308, and the selection unit 309 may advance the processing by exchanging information with each other. Processing in which the analysis unit 307 reads out the history information from each model file and performs processing such as statistical analysis, the selection unit 309 selects, based on a processing result, a model to be presented to the user, the display control unit 308 presents the model to the user and receives button pressing information, and then the analysis unit 307 reads out the history information again based on it may be repeated.

As described above, according to this embodiment, it is possible to present information for simplifying model selection to the user without imposing, on the user, the complexity of individually managing the model file and the history information.

### Third Embodiment

This embodiment will describe a case where history information is statistically analyzed, thereby providing information of model selection and proposing incremental learning. This embodiment will describe a case where the user selects an image-quality enhancing model as a learning model that has learned image quality enhancement from a cloud server 200 (learning model public platform). Note that this embodiment does not limit the learning model to the image-quality enhancing model, and may use a model that executes a general task such as image generation, image recognition, sound processing, and language processing.

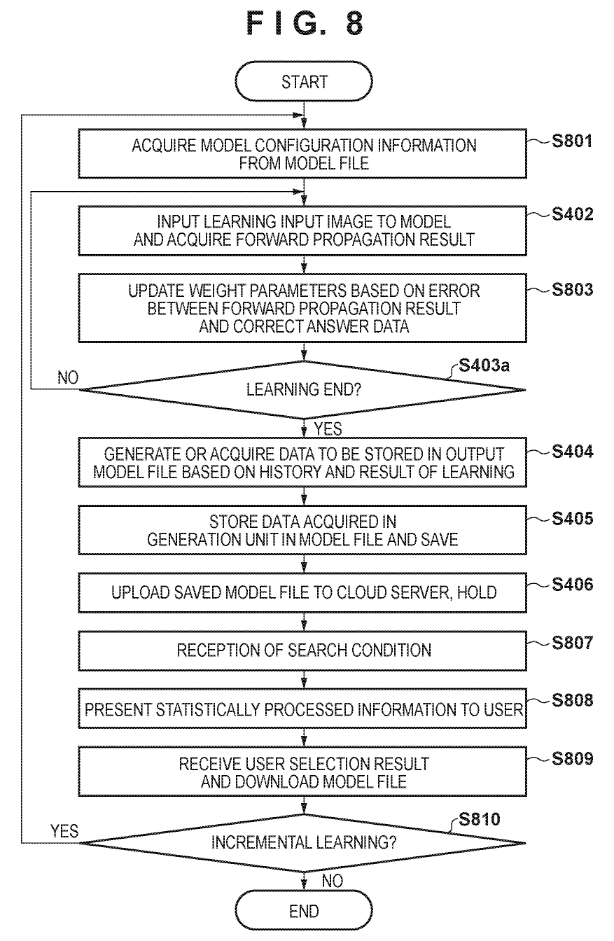

The operation of a device 100 will be described with reference to the flowchart of FIG. 8. In FIG. 8, the same step numbers of processing steps as in FIG. 4 denote the same processing steps and a description thereof will be omitted.

In step S801, an acquisition unit 301 transmits an acquisition request of a model file of a learning model as an incremental learning target to the cloud server 200, and receives the model file transmitted by the cloud server 200 in accordance with the acquisition request. Then, the acquisition unit 301 reads out model configuration information and various kinds of history information from the received model file.

In step S402, a forward propagation unit 302 acquires learning data from "a link to the acquisition source of the learning data" that is the history information (item 508) of the learning model. The acquisition source of the learning data is not limited to the link.

Then, the forward propagation unit 302 inputs a learning image to the learning model and performs an operation (forward propagation) of the learning model, thereby acquiring an image-quality enhancement result of the learning image as a forward propagation result. In the image-quality enhancing task, the learning image is an image obtained by decreasing the image quality of a high-quality supervisory image, and the forward propagation result is a predicted image-quality enhancement result.

In step S803, an evaluation unit 303 calculates, as an evaluation value, an error (loss value) between the forward propagation result acquired in step S402 and correct answer data. Then, the evaluation unit 303 updates current weight parameters set in the learning model so as to decrease the evaluation value.

The evaluation unit 303 acquires a data set for evaluation from "the acquisition source of the data set for evaluation" that is the history information (item 506) of the learning model. Then, the evaluation unit 303 evaluates the learning result of the learning model using the data set for evaluation by a calculation method defined in the history information (item 507) of the learning model, and calculates the value as an evaluation value of evaluation.

Note that in step S404 according to this embodiment, a generation unit 304 further acquires an evaluation value for evaluation. Then, in step S405 according to this embodiment, a storage control unit 305 stores the evaluation value for evaluation as history information in the model file. This can compare the plurality of model files on the same scale using the evaluation values for evaluation.

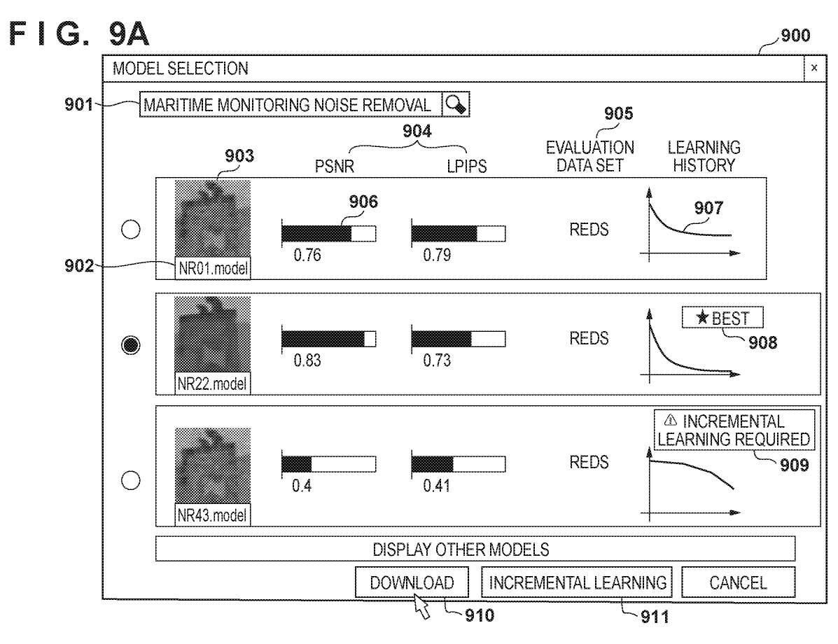

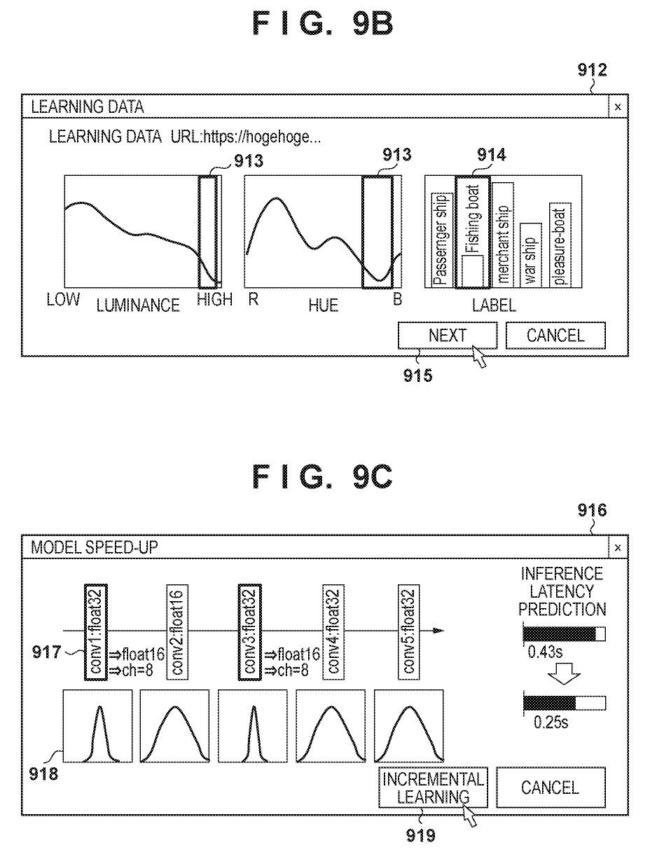

In step S807, a display control unit 308 displays a dialog window 900 exemplified in FIG. 9A on a display device 40, and prompts the user to input, to a box 901, a search condition of a learning model to be acquired. The user inputs, to the box 901 using an input device 20, a search condition of a learning model to be acquired.

When the user inputs a search instruction using the input device 20, an analysis unit 307 requests the cloud server 200 to search for learning models under the search condition and transmit the model files of the learning models found by the search.

The cloud server 200 performs a search in accordance with the request to search for model files matching the search condition input by the user, and transmits the found model files to the device 100. The analysis unit 307 acquires (receives) the model files transmitted from the cloud server 200.

In step S808, the display control unit 308 displays, on the window 900, information included in each model file acquired by the analysis unit 307 from the cloud server 200, as exemplified in FIG. 9A.

The information displayed on the window 900 includes a model name 902 of the learning model, a forward propagation result 903, an evaluation scale 904 at the time of past evaluation, a data set 905 used for evaluation, a history 906 of a past evaluation value for evaluation, and a transition 907 of the evaluation value or the evaluation value for evaluation.

The evaluation value helps the user to grasp performance by displaying a statistical value such as a past average value. The display control unit 308 performs display 908 to recommend, to the user, a model file with the best evaluation value for evaluation among the displayed model files.

Furthermore, the display control unit 308 performs display 909 to recommend incremental learning to the user by determining, based on the history of the evaluation value or the evaluation value for evaluation, that the model file of a learning model for which an amount of improvement for a predetermined period (an increment from a lowest value to a highest value within a predetermined period) is equal to or larger than a threshold can be expected to be improved by incremental learning.

FIG. 9A shows a state in which a model file whose model name 902 is "NR22.model" is selected. When the user makes an instruction on a button 910 using the input device 20, a selection unit 309 transmits an acquisition request of the model file of the learning model selected by the user to the cloud server 200. The cloud server 200 transmits, to the device 100, the model file corresponding to the acquisition request.

When the user presses a button 911 using the input device 20, the mode shifts to an incremental learning recommendation mode. When the mode shifts to the incremental learning recommendation mode, the display control unit 308 displays a window 912 exemplified in FIG. 9B on the display screen of the display device 40.

To recommend incremental learning using "a link to the acquisition source of learning data" stored as an item 508, the display control unit 308 displays "the name of the learning data" stored as the item 508 on the window 912.

In addition, the display control unit 308 acquires "statistical information of samples used in learning processing" stored as an item 511 and displays it as color distributions 913 of luminance and hue on the window 912. The display control unit 308 displays rectangles (thick frames in FIG. 9B) representing proposed locations in a luminance region where the existence ratio is lower than a threshold in the color distribution 913 of luminance and a hue region where the existence ratio is lower than a threshold in the color distribution 913 of hue, thereby proposing learning by augmenting data of luminance/hue with the low existence ratio.

The display control unit 308 displays, on the window 912, a distribution 914 of subject categories (classification) in learning data used in past learning processing, and displays a rectangle (a thick frame in FIG. 9B) representing a proposed location for a category whose content ratio is lower than a threshold, thereby proposing downloading an image of a subject of the category whose content is low from the Web and adding it to the learning data (proposing a subject to be learned more).

By using the input device 20, the user instructs each proposed location to perform adoption/rejection/content editing, and makes an instruction on a button 915. When the button 915 is instructed, the display control unit 308 displays a window 916 exemplified in FIG. 9C on the display screen of the display device 40 in order to reduce the weight of the learning model obtained after incremental learning.

The display control unit 308 refers to "the characteristic of each layer of a learning model" stored as an item 513, and performs, on the window 916, display 917 to indicate the name of each layer and the number of operation bits and display 918 to indicate the distribution and rank of the output matrix of the layer.

The display control unit 308 determines that a layer with a small variance of the distribution and a layer with a low rank do not require calculation accuracy as high as current accuracy, and performs display to propose incremental learning by reducing the number of operation bits and the number of channels. That is, the display control unit 308 determines, as proposal target layers, a layer with a variance of the distribution smaller than a threshold and a layer with a rank lower than a threshold, and displays rectangles (thick frames in FIG. 9B) for the proposal target layers as display to propose incremental learning by reducing the number of operation bits and the number of channels. By using the input device 20, the user instructs each proposed location to perform adoption/rejection/content editing, and makes an instruction on a button 919.

In step S809, when the user instructs the button 910 using the input device 20, the selection unit 309 transmits an acquisition request of the model file of the learning model selected by the user to the cloud server 200. The cloud server 200 transmits, to the device 100, the model file corresponding to the acquisition request.

In step S810, the display control unit 308 determines whether the button 911 is instructed. As a result of the determination processing, if the button 911 is instructed, the process returns to step S801. Then, in learning processing, the forward propagation unit 302 decides learning data to be actually used from the learning data corresponding to the model file selected on the window 900 by an augmenting method designated on the window 912, and performs forward propagation with incremental learning contents designated on the window 916. On the other hand, if the button 911 is not instructed, the processing according to the flowchart of FIG. 8 ends.

This embodiment has explained a case where a model file on the learning model public platform is selected, but other model files may be included as selection options. For example, a model file learned by the user on the device 100 or a model file received from another device 110 or 120 may be a selection target.

This embodiment has explained a case where the user selects a model file by visual observation, but the selection unit 309 may automatically select a model file (without intervention of a user operation). A part of selection may be automated. For example, the display control unit 308 may display, as selection candidates, a predetermined number of model files in ascending order of evaluation values for evaluation on the window 700 and requires the user to manually select a model file from them.

The method of proposing to the user described in this embodiment is merely an example, and other information for selecting a model file or other recommendation contents may be displayed, and another instruction may be received from the user.

As described above, according to this embodiment, it is possible to present, to the user, information for simplifying model incremental learning based on the statistical information of the history without imposing, on the user, the complexity of individually managing the model file and the history information.

The numerical values, processing timings, processing orders, the main constituent of processing, the structures/acquisition methods/transmission destinations/transmission sources/storage locations of data (information), and the like used in the above-described embodiments are merely examples used to make a detailed description, and it is not intended to limit to these examples.

Some or all of the above-described embodiments may appropriately be combined and used. In addition, some or all of the above-described embodiments may selectively be used.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-078877, which was filed on May 9, 2025 and which is hereby incorporated by reference herein in its entirety.

What is claimed is:

1. An information processing apparatus comprising:
at least one processor; and
at least one memory that is in communication with the at least one processor, wherein the at least one memory stores instructions for causing the at least one processor and the at least one memory to:
acquire configuration information defining a learning model;
acquire history information indicating a history concerning processing of the learning model; and
generate an output file of the learning model by storing the configuration information and the history information in a file storing the learning model.

2. The information processing apparatus according to claim 1, wherein the configuration information includes information defining a hierarchical structure of the learning model.

3. The information processing apparatus according to claim 1, wherein the configuration information includes a weight parameter of the learning model.

4. The information processing apparatus according to claim 1, wherein the history information includes a history of an input image input to the learning model and a history of a forward propagation result corresponding to the input image.

5. The information processing apparatus according to claim 4, wherein the input image includes an image used for learning processing of the learning model.

6. The information processing apparatus according to claim 4, wherein the input image includes an image for inference used for inference by the learning model.

7. The information processing apparatus according to claim 4, wherein the input image includes an image for evaluation used for evaluation of learning processing of the learning model.

8. The information processing apparatus according to claim 1, wherein the history information includes a history of an image obtained by post-processing an input image input to the learning model and a history of a result of post-processing a forward propagation result corresponding to the input image.

9. The information processing apparatus according to claim 1, wherein the history information includes statistical information of learning data used for learning processing of the learning model.

10. The information processing apparatus according to claim 1, wherein the history information includes a value of statistical processing on at least one of a history of an input image input to the learning model, a history of a forward propagation result corresponding to the input image, and the history concerning the processing of the learning model.

11. The information processing apparatus according to claim 1, wherein the history information includes a history of an error between correct answer data corresponding to an input image input to the learning model and a forward propagation result corresponding to the input image.

12. The information processing apparatus according to claim 11, wherein the history information includes an identifier of information concerning a method of calculating the forward propagation result.

13. The information processing apparatus according to claim 1, wherein the history information includes a name of learning data used for learning processing of the learning model, a link to an acquisition source of the learning data, a license of the learning data, a model name of the learning model, a link to a file of the learning model, information concerning a creator of the learning model, an identifier of a user who has instructed to execute the learning processing, an identifier of a node that has executed the learning processing, date/time when the learning processing is executed, and statistical information of samples used for the learning processing.

14. The information processing apparatus according to claim 1, wherein the at least one memory further stores instructions for causing the at least one processor and the at least one memory to divisionally store the history information in a region for describing overall information of the learning model and a region for describing information in the learning model.

15. The information processing apparatus according to claim 1, wherein the at least one memory further stores instructions for causing the at least one processor and the at least one memory to store the configuration information in a region for describing information in the learning model.

16. The information processing apparatus according to claim 1, wherein the at least one memory further stores instructions for causing the at least one processor and the at least one memory to store a history of a characteristic of each layer of the learning model in association with the configuration information in a region for describing information in the learning model.

17. The information processing apparatus according to claim 1, wherein the at least one memory further stores instructions for causing the at least one processor and the at least one memory to control, by exclusive control, the storage in the file by a plurality of threads.

18. The information processing apparatus according to claim 1, wherein the at least one memory further stores instructions for causing the at least one processor and the at least one memory to:
download the file,
acquire the configuration information from the downloaded file, and
acquire the history information from the downloaded file.

19. The information processing apparatus according to claim 1, wherein the at least one memory further stores instructions for causing the at least one processor and the at least one memory to upload the output file.

20. The information processing apparatus according to claim 1, wherein the learning model is a hierarchical neural network.

21. The information processing apparatus according to claim 1, wherein the at least one memory further stores instructions for causing the at least one processor and the at least one memory to acquire, as a file of a series model, a file including history information in which a file of a learning model selected by a user is described, and perform display based on the acquired file.

22. The information processing apparatus according to claim 21, wherein the at least one memory further stores instructions for causing the at least one processor and the at least one memory to display a relationship between the series model and the learning model selected by the user.

23. The information processing apparatus according to claim 21, wherein the at least one memory further stores instructions for causing the at least one processor and the at least one memory to display a file of a learning model as a selection candidate based on a result of evaluation for learning processing.

24. The information processing apparatus according to claim 1, wherein the at least one memory further stores instructions for causing the at least one processor and the at least one memory to acquire, as a file of a derived model, a file including history information in which a file of a learning model selected by a user and a file of a series model of the learning model are described, and perform display based on the acquired file.

25. The information processing apparatus according to claim 24, wherein the at least one memory further stores instructions for causing the at least one processor and the at least one memory to display a relationship among the learning model selected by the user, the series model, and the derived model.

26. The information processing apparatus according to claim 1, wherein the at least one memory further stores instructions for causing the at least one processor and the at least one memory to display, based on history information of a file of a found learning model, a color distribution of a learning image used for learning processing of the learning model and a distribution of a subject in the learning image used for the learning processing of the learning model.

27. The information processing apparatus according to claim 26, wherein the at least one memory further stores instructions for causing the at least one processor and the at least one memory to perform display to recommend incremental learning with respect to a learning model for which an amount of improvement of an evaluation value for a learning result based on a history of the evaluation value is not smaller than a threshold.

28. The information processing apparatus according to claim 26, wherein the at least one memory further stores instructions for causing the at least one processor and the at least one memory to perform, based on the color distribution, display to propose luminance and hue to be learned by augmenting.

29. The information processing apparatus according to claim 26, wherein the at least one memory further stores instructions for causing the at least one processor and the at least one memory to perform, based on the distribution of the subject, display to propose a subject to be learned more.

30. The information processing apparatus according to claim 26, wherein the at least one memory further stores instructions for causing the at least one processor and the at least one memory to perform display to indicate a name of each layer of the learning model and the number of operation bits and display to indicate a distribution and a rank of an output matrix of the layer.

31. The information processing apparatus according to claim 26, wherein the at least one memory further stores instructions for causing the at least one processor and the at least one memory to perform display to propose incremental learning for a layer with a variance of a distribution smaller than a threshold and a layer with a rank lower than a threshold in the learning model.

32. The information processing apparatus according to claim 1, wherein the at least one memory further stores instructions for causing the at least one processor and the at least one memory to perform inference using the learning model,
wherein the history information includes information concerning the inference.

33. An information processing method executed by an information processing apparatus, the information processing method comprising:
acquiring configuration information defining a learning model;
acquiring history information indicating a history concerning processing of the learning model; and
generating an output file of the learning model by storing the configuration information and the history information in a file storing the learning model.

34. A non-transitory computer-readable storage medium storing a computer-executable instructions for causing a computer to:
acquire configuration information defining a learning model;
acquire history information indicating a history concerning processing of the learning model; and
generate an output file of the learning model by storing the configuration information and the history information in a file storing the learning model.
